(19) United States
(12) Patent Application Publication
(10) Pub. No.: US 2008/0314051 A1
(43) Pub. Date: Dec. 25, 2008

(54) SYSTEM AND METHOD FOR CRYOGENIC PROCESSING AND MANUFACTURING OF MATERIAL

(76) Inventor: Charles Patrick McKee, Rogersville, MO (US)

Correspondence Address: HUSCH BLACKWELL SANDERS LLP, 720 OLIVE STREET, SUITE 2400, ST. LOUIS, MO, 63101, US

(21) Appl. No.: 12/031,402

(22) Filed: Feb. 14, 2008

Related U.S. Application Data
(60) Provisional application No. 60/889,864, filed on Feb. 14, 2007.

(51) Int. Cl. F17C 13/00

(52) U.S. Cl. 62/51.1

(57) ABSTRACT

An apparatus and method for cryogenic processing comprising a chamber having a specially optimized configuration and geometry and having internal insert array of pathways and supporting elements to facilitate advanced materials processing. The pathways and supporting components can be configured by bending and positioning in different planes with bending the pathways with optimal radii and in different planes. The pathways bending radii can be within an optimal range for the size of the chamber and the angles between the pathway bending planes can be within an optimal range. The angles between the supporting components positioning planes and the pathway bending planes can be in an optimal range. The invention can also include structural supporting components that are attached at the pathway small movement points and the length of attachment can vary from about approximately zero to the full length of the supporting component. A space can be provided between pathway and supporting components or between the array and the chamber walls allowing their independent movement and product exchange

### CROSS-REFERENCE TO RELATED APPLICATIONS

This application is a non-provisional application claiming the benefit of provisional Patent Application Ser. No. 60/889,864 filed Feb. 14, 2007 the entire disclosure of which is incorporated herein by reference.

### BACKGROUND OF INVENTION

1. Field of Invention

This invention relates generally to manufacturing and processing advanced material and, more particularly, to cryogenic processing and manufacturing such material.

2. Background Art

Cryogenic chambers are often utilized to process advanced materials such a pharmaceuticals. A cryogenic chamber can be utilized to freeze pharmaceuticals or other materials for long term storage. However, the cryogenic freezing process can often cause the material such as a pharmaceutical solution, to separate into its subcomponents such as the proteins or salt. This can result in an improper concentration of the material. For example the salt and protein may separate out during the cryogenic process. This can be referred to as cryogenic concentration. In order to counteract this effect, the process has to freeze from the center of the vessel out to the sides and from the bottom to the top. This requires a controlled heat exchange rate and distribution. Freezing before the solution separates is desired.

Various cryogenic chamber designs have been used and can be used to heat or cool a medium or material and the chamber can have a heat exchange fluid circulated in tubes placed in or around the exterior of the container. In order to improve the transfer of heat to or from the medium to the heat exchange fluid, one or more extensions of the container or any structures in the container can be used to increase the surface area of the system that is in contact with the medium. Fins are often utilized to improve heat exchange and can be attached by one end to a portion of the container or some other structure in the container, and the fins can conduct heat to or from that portion of the container. A fin can be attached to the container or an internal structure at only one point, all of the heat transferred to or from the fin to the container or an internal structure can enter or leave the fin through the one connection that the fin has with the rest of the system. The fins can be rigidly attached to both the container and an internal structure within the container. This allows heat to be transferred to or from a fin through two portions of the fin, increasing the rate at which heat is put into or withdrawn from a medium placed in the container.

However, many cryogenic chambers having refrigerant tubing suffer from the same cryogenic concentration effect. A cryogenic chamber design is needed to avoid this effect.

### BRIEF SUMMARY OF INVENTION

The invention is a chamber having a specially optimized configuration and geometry and having internal insert array of pathways and supporting elements to facilitate advanced materials processing. The pathways and supporting components can be configured by bending and positioning in different planes with bending the pathways with optimal radii and in different planes. The pathways bending radii can be within the range about approximately 0 inch to 400 inches and the angles between the pathway bending planes within the range of about approximately 0 deg to 180 deg. The angles between the supporting components positioning planes and the pathway bending planes can be in the range between about approximately 0 deg and 180 deg.

The invention can also include structural supporting components that are attached at the pathway small movement points and the length of attachment can vary from about approximately zero to the full length of the supporting component. A space can be provided between pathway and supporting components or between the array and the chamber walls allowing their independent movement and product exchange and this space can be of simple or complex geometry and the space dimensions can vary within the range between about approximately 0 inch and 80 inch and the geometry can involve constant or changing space with linear, nonlinear or discrete dimensional changes.

The supporting components can be solid or have openings. The supporting components can have their surface coated, profiled or have extended surface configuration—they can be flat, corrugated, wavy, or spanning an arc being a part of a circle, spiral, hyperbole, ellipse or other 2- or 3-dimensional curvatures, or form geometrical shapes regular or irregular. The planes of supporting components may or may not align with the external pathway array bending planes. FIGS. 1 and 2 show examples of configurations where the bending planes of internal pathway array are and are not aligned with the planes of supporting components respectively.

The internal array may be attached to the chamber walls or be freely suspended. The chamber and its internal array can be stationary or mobile. The system can operate within wide range of pressure and temperature, from full vacuum to elevated pressures (for example, up to about approximately 20,000 psi) and from very low to high temperatures (for example, within the range of about approximately −269 deg C. to 1,680 deg C.). The internal array configuration and geometry is such to provide optimized processing conditions for changing material properties and provides compensation for extreme processing conditions-generated stress and deformation.

The operation can involve agitation using array movement, whole system movement, relative movement of system and array, chamber movement, relative movement of chamber, system and array, product circulation, other medium injection, mechanical agitator/mixer, pulsation device, vibrating or oscillating device, or a bladder or bellows. The chamber walls and the array can be rigid or flexible with steady or changing shape and dimensions.

The pathways and supporting components can form processing zones, with identical or varying zone geometry. The processing zones can be formed by pathways, supporting components, or combinations of both. The bends of pathways in the central and peripheral processing zones can be such that the pathways come to a close proximity to the chamber wall within the range between about approximately 0 inch and 85 inches. Thickness of supporting components can be constant or variable within the component and can vary from about approximately 0.000001 inch to 88 inches.

The distances between array pathways can vary from about approximately 0 to 120 inches. The distances between array supporting components can vary from about approximately 0 to 160 inches. The array of pathways is configured to allow the medium inside the pathway ducts to move from one side of the chamber to another in certain predetermined sequence thus allowing uniform interaction between the medium and the material in the chamber. The supports S can be attached to the supporting components or to the pathways of the array. The array can be configured with inner and outer pathways with the number of outer pathways increasing with the chamber dimensions. The array can have various configurations of connections between the inner and outer pathways with connections varying in radii and bending planes. The bending of pathways in the central and peripheral parts of the array can be in parallel or crossing planes. The distances between pathways in crossing planes can be within the range from about approximately 0 to 160 inches.

The pathways and supporting components can be connected in multiple or single areas, or they can be not connected, but remain in a proximity with the distance range from about approximately 0 inch to 120 inches. The supporting components can at various distances form the pathways, other components or the chamber walls with the distance range from about approximately 0 to 160 inch. The internal and external surfaces of pathways can be smooth, rough, corrugated, dimpled, ribbed, grooved, or extended by other geometrical shapes regular or irregular. The cross-sections of pathways can be circular, oval, elliptical, square, rectangular, triangular, flattened in different planes, or change irregularly.

The approximate dimensions and specifications provided herein can vary substantially depending on the size of the cryogenic chamber being utilized. The approximate specifications and dimensions defined herein could be utilized for example with a cryogenic chamber having a container with a capacity of about approximately 100 liters. The dimensions and specifications of the insert can vary substantially depending on the size of the chamber without departing from the scope or spirit of the invention. Also, an insert can be configured to create more zones depending on the diameter of the chamber.

These and other advantageous features of the present invention will be in part apparent and in part pointed out herein below.

### BRIEF DESCRIPTION OF THE DRAWINGS

For a better understanding of the present invention, reference may be made to the accompanying drawings in which:

FIG. 1 is a perspective view of a chamber insert;

FIG. 2 is a top plan view of the chamber insert;

FIG. 3 is a side plan view of the chamber insert;

FIG. 4 is a rear plan view of a channel insert;

FIG. 5 is a front plan view and a top plan view of the channel insert; and

FIG. 6 is a side plan view of the channel insert;

FIG. 7 is a sectional view of the lower portion of the tubing; and

FIG. 8 is another sectional view of the lower portion of the tubing.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF INVENTION

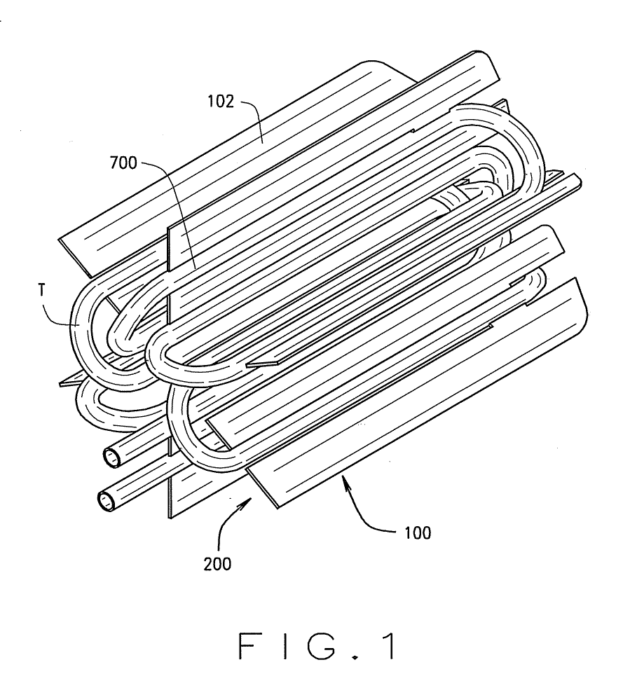

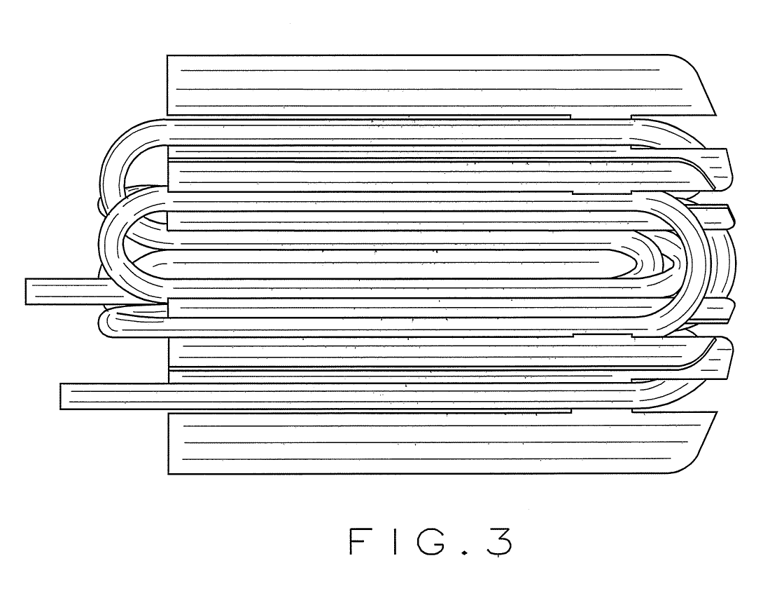

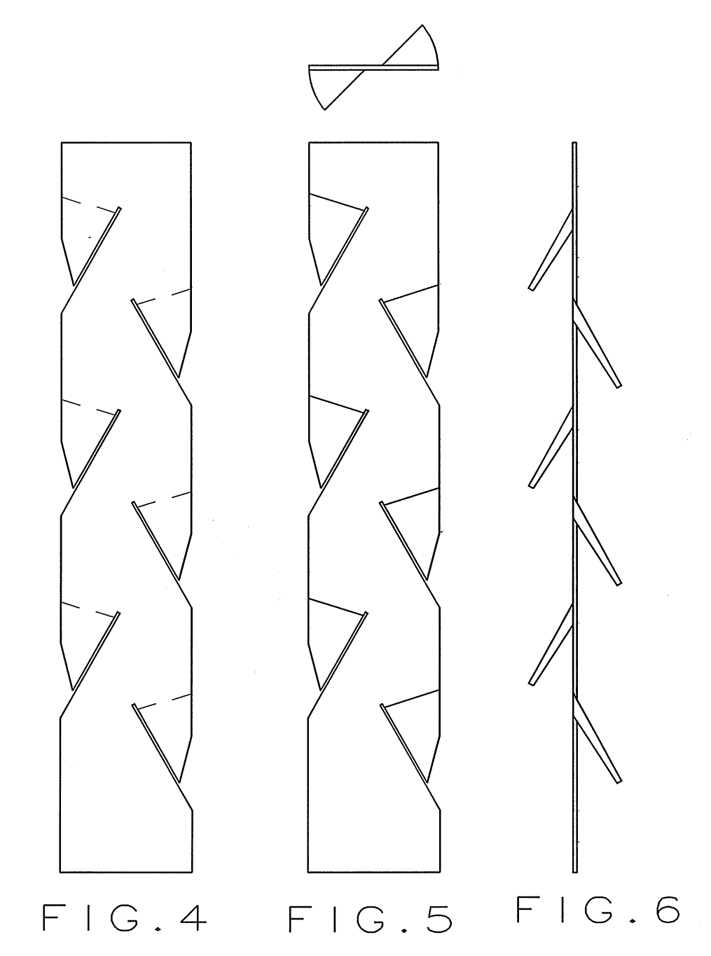

According to the embodiment(s) of the present invention, various views are illustrated in FIG. 1-8 and like reference numerals are being used consistently throughout to refer to like and corresponding parts of the invention for all of the various views and figures of the drawing. Also, please note that the first digit(s) of the reference number for a given item or part of the invention should correspond to the Fig. number in which the item or part is first identified.

One embodiment of the present invention comprising a cryogenic chamber including an internal insert array of pathways, heat exchanger fins and supporting elements teaches a novel apparatus and method for cryogenic manufacturing and processing of special materials.

The invention presents systems, processes and methods for manufacturing and processing of complex products, substances and advanced materials. The systems and methods presented herein can be used for processing of various advanced products, materials and substances, for example: chemical, semiconductor, nanomaterials, biological, nutritional or pharmaceutical products. The system can accommodate processes using extreme operational conditions including high or low temperatures, extreme pH, high concentration of hazardous materials, high pressure or full vacuum, and materials with properties changing during processing.

The details of the invention and various embodiments can be better understood by referring to FIGS. 1-8 of the drawing.

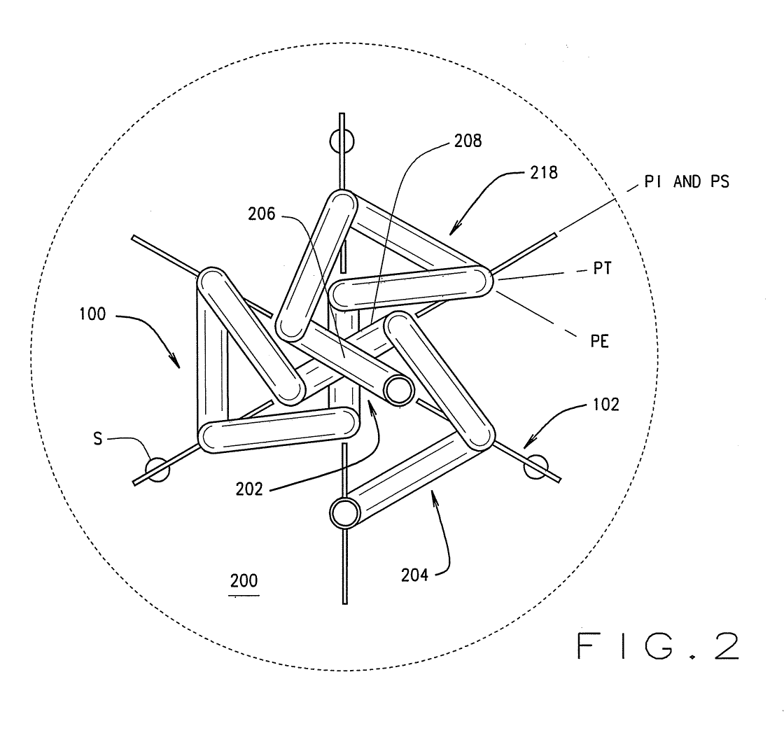

The processing system comprises a chamber [200] with an especially configured insert array [100]. The configuration of insert array [100] and its position in the chamber are critical for processing of substances and materials. The insert array can be made as a combination of hollow conduits and solid components. FIGS. 1 and 2 shows an example of a chamber [200] with the insert array [100] allowing for high array flexibility if there are forces involved with material processing, or there is a thermal expansion or contraction of the array, or the processed materials, or both. The array [100] is configured to easily compensate for the displacements and with minimized stress generated in itself. In this example, the array is built from the main pathway [700] with multiple turns T and the supporting components [102].

The pathways and supporting components [102] can form processing zones. These zones can be identical or vary in geometry within the chamber. FIG. 1 shows an example where the central zone 202 is different than the peripheral zones 204. The array can be formed by a combination of bent pathways and supporting components. The bent pathways can have various bend planes and the supporting components can be located in various planes as well. These planes may be parallel, crossing, or overlapping. In this embodiment the central zone pathway bends cross at the chamber wall. The planes of those bends cross along the centerline 206.

In other embodiments these pathways may not cross and face outwards, or the bends planes can be parallel or cross not in the centerline. The bends in the peripheral processing zones can form bend planes that are parallel or cross under various angles. The bends of the central zone can form a combination of parallel and crossing planes. The bends of pathways in the central and peripheral processing zones can be such that the pathways come to a close proximity to the chamber wall, for example in the range between about approximately 0 inch and 85 inch. In this example the peripheral zones include the components [102] and the central zone does not. In other embodiment of this invention the central zone can have components [102] as well, spanning across the zone. In general, the processing zones can be formed by pathways, supporting components, or combinations of both. Thickness of supporting components can be constant or variable within the component and can vary from about approximately 0.000001 inch to 88 inch.

The pathway [700] can be for example, a pipe or a conduit. In this example, the supporting components [102] are shown as simple ones with the supports S, but can be of complex geometry with extensions and complex surface structure. For example, the surface can be of different roughness, be coated, profiled (wavy), or have extensions such as studs, dimples or bent cutouts. The supports S can contact pathways [700] or supporting components [102]. In this example of array [100] they are in contact with the supporting components [102].

The bending radii of pathway [700] turns are configured to minimize stress. The bending in different planes permits the array [100] to flex in multiple directions. Such a configuration not only allows great structural flexibility, but also acts towards dampening of array vibrations and dynamic movements. Therefore, vibrational or other type of motions can be imposed upon the whole system, the array itself, or the system components to enhance the process. The array of pathways is configured to allow the medium inside the pathway ducts to move from one side of the chamber to another thus allowing uniform interaction between the medium and the material in the chamber. FIG. 2 shows an example of such configuration with the pathways [700] traversing from inner section of the array to outer section and also from side to side of the chamber to provide such medium-material interaction uniformity. Examples of such interactions can be heating or cooling.

FIG. 2 shows an example with the supporting components [102] being attached to the array main path over the short length L only, and otherwise they are also free to move and flex as the process proceeds. The attachment is where the pathway [700] part movements can be the smallest. The length L can vary from zero to the full length of the supporting component. In other embodiments of this invention the supporting components [102] can be solidly attached to the pathways. In other embodiments the supporting components [102] may not be attached to the pathways [700]. There is an open space [202] between the supporting components [102] and the array pathway [700] permitting their independent movements. This space can be also beneficial for some processes by permitting substrates and products exchange between the processing zones.

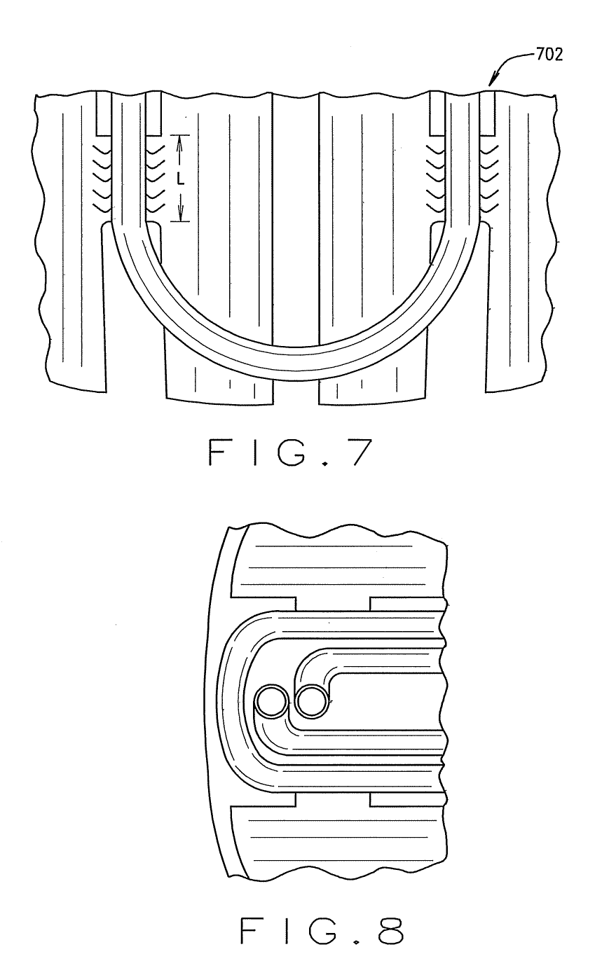

FIG. 7 shows an example of the system with the space [702] between pathways and supporting components being completely open for the pathways of central processing zone and partly open for the external processing zones (with exception of attachment L connection). Other embodiments can have connection L also present for the central processing zone with supporting components [102]. The space dimensions can vary broadly and this space can be of simple or complex geometry. For example, the space shown in FIG. 7 can be within the range between about approximately 0 inch and 80 inch.

The complex geometry can involve changing space with linear, nonlinear or discrete dimensional changes. For example, the distance between the pathway and supporting component may be constant or converging, diverging in linear or nonlinear pattern, or change in a discrete way, such as a saw-tooth, zig-zag, multi-step, or in a wavy fashion. A similar space geometry and dimensions with certain ranges can occur between the chamber wall and the array supporting components or pathways, permitting substrates and products exchange between the processing zones.

The supporting components [102] can be solid or have openings. For example, a perforated plate can be used. In summary, the pathways [700] and supporting components [102] can be configured by bending the pathway with optimal radii and positioning in different planes to allow maximal flexibility and individual supporting components attached to pathway in the pathway low movement points and providing space between pathway and supporting components allowing their independent movement and product exchange.

Critical factors of such configuration can be the pathway turns T bending radii, angles between the planes of pathway bending, and angles between pathway bending planes and supporting components positioning planes. The pathway bending radii can be within the range: of about approximately 0 to 180 deg and the angles between the pathway bending planes within the range: of about approximately 0 to 180 deg. The angles between the supporting components positioning planes PS and the pathway bending planes PI, PT and PE can be in the range: from about approximately 0 to 180 deg.

FIG. 2 shows an example of multiple bending planes of the pathway [70] and supporting components [102]. In this example, there are internal pathway [208] array bending planes PI interacting with the pathway transition bending planes PT to connect with the external pathway array [210]. In this case the angle between those planes is larger than about approximately 90 degrees for more flexibility. The angle between transition plane PT and the bending plane of the array is smaller than about approximately 90 degrees to provide displacement compensation. In this example the planes PS of supporting components [102] do not agree with the external pathway array [210] bending planes PE. In this particular configuration the planes PS of supporting components [102] are aligned with the bending planes PI of the internal pathway array [208], but in general they can be different from the internal array bending planes. The example shows the internal [208] and external [210] pathways positioned on r and R radii, but the array can have pathways positioned on more than two radii.

FIG. 2 shows an example with a configuration where the bending planes PI of internal pathway array [208] are not aligned with the planes PS of supporting components [102].

However the central zone pathways can cross at different planes. Also, the supporting component [102] can be attached to the pathway [208] and the option where there is no connection between the pathway and the supporting component. The distances between crossing pathways can vary between about approximately 0 inch and 160 inch. This example shows the bends of pathways turning inwards to form the internal zone of array—other configurations can include the pathways bent outwards or sideways.

An array of pathways with supporting components can fill the chamber volume with different array density, from a few pathways with supporting components to a densely packed array comprising very large numbers of pathways and supporting components. The array configuration serves multiple purposes, for example, allows flexibility and displacement compensation and provides uniformity of interaction of media in the pathways and material in the chamber. Such characteristics provide favorable conditions to operate within very wide ranges of operating parameters, bear process-related forces, process materials with changing characteristics and process sensitive materials.

The chamber walls and the array can be rigid or flexible. The pathways and supporting components can have steady or changing dimensions, for example expanding and contracting. By the change in shape and dimensions they can aid in material mixing and material exchange among processing zones. The system can operate within the wide range of operating conditions, such as pressures and temperatures—from full vacuum to elevated pressures (for example, up to about approximately 20,000 psi) and within the temperatures from very low to elevated (for example, within the range of about approximately −269 deg C. to 1,680 deg C.).

The internal and external parts of array configuration can provide compensation for changing material properties and extreme processing conditions-generated stress and deformation. The system operation can include agitation using array movement, whole system movement, relative movement of system and array, product circulation, other medium injection, mechanical agitator/mixer, pulsation device, vibrating or oscillating device, or a volume changing devices such as bladder, balloon or bellows.

Mixing of material can be aided by array and chamber wall flexibility. Agitating devices can be located in the central or peripheral zones. An example of flexible array can be an array with rigid pathways [700] and flexible supporting components [102]. Components can be solid or have openings. The distances between array pathways can vary for different embodiments including inner and outer parts of array. The range of these distances can be from about approximately 0 to 120 inch. The distances between array supporting components can vary for different embodiments including inner and outer parts of array. The range of these distances can be from about approximately 0 to 160 inch.

A unique and proprietary insert is placed into the ducts, channels or pipes as well as in the jackets and in general, on the flowing medium side. The inserts direct the medium flow in a way to intensify the processes in the processing chamber, or in general on the processed product side. FIGS. 4-6. shows an example of such an insert. The cuts are made and bent forming a sequence of opening and associated blades. The sequence of cuts, the depth of cuts, and the angles of cuts as well as angle of bending can vary depending on media and application. In general, the distance between the cuts can vary in the range between about approximately 0.001 to 75 of the band width and the cut angles can vary from about approximately 0.25 deg to 179.75 deg. The bend angles can vary from about approximately 0.001 deg to 179.999 deg. The depth of cuts can vary between about approximately 0.001 of band width to about approximately 0.999 of band width. Within these ranges an optimal geometry is found for process applications and processing system design.

This is an example of one embodiment. The cuts can be straight or curvilinear. The curvature of cut can be constant or change along the blade. The curvilinear cuts can further improve system performance due to optimized flow of the media along the path. The bent blades of cuts can be flat or curvilinear. The curvilinear blade shape can optimize the flow of certain media, for example the non-Newtonian. The blades can be curvilinear in two- or three-dimensions, forming complex-shaped surfaces. The surface curvature can be constant or change along and across the blade. Other embodiments can add an longitudinal twist to the band in addition to the cuts. The band twisting can be unidirectional or periodically change the twisting direction. A helical twisting is an example of the twisted embodiment. Other twisting embodiments can be step-wise, following the cuts pattern along the band.

The various cryogenic system and method examples shown above illustrate a novel system and method for cryogenic processing and manufacture of an advanced material. A user of the present invention may choose any of the above cryogenic system embodiment, or an equivalent thereof, depending upon the desired application. In this regard, it is recognized that various forms of the subject cryogenic process could be utilized without departing from the spirit and scope of the present invention.

As is evident from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the present invention.

Other aspects, objects and advantages of the present invention can be obtained from a study of the drawings, the disclosure and the appended claims.

What is claimed is:

1. A Specially optimized configuration and geometry of a chamber and its internal insert array of pathways and supporting elements to facilitate advanced materials processing comprising:
Pathways and supporting components configured by bending and positioning in different planes with bending the pathways with optimal radii and in different planes, where said pathways bending radii can be within the range of about approximately 0 inch to 400 inch and the angles between the pathway bending planes within the range of about approximately 0 deg to 180 deg.

2. The chamber of claim 1, where the angles between the supporting components positioning planes and the pathway bending planes can be in the range between about approximately 0 deg and 180 deg.

3. The chamber of claim 2, where the structural supporting components are attached at the pathway small movement points and the length of attachment can vary from zero to the full length of the supporting component.

4. The chamber of claim 3, where a space is provided between pathway and supporting components or between the array and the chamber walls allowing their independent movement and product exchange and this space can be of simple or complex geometry and the space dimensions can vary within the range of about approximately between 0 inch and 80 inch and the geometry can involve constant or changing space with linear, nonlinear or discrete dimensional changes.

5. The chamber as recited in claim 4 where the supporting components can be solid or have openings.

6. The chamber as recited in claim 5, where the supporting components can have their surface coated, profiled or have extended surface configuration—they can be flat, corrugated, wavy, or spanning an arc being a part of a circle, spiral, hyperbole, ellipse or other 2- or 3-dimensional curvatures, or form geometrical shapes regular or irregular.

7. The chamber as recited in claim 6, where the planes of supporting components may or may not align with the external pathway array bending planes. FIGS. 1 and 2 show examples of configurations where the bending planes of internal pathway array are and are not aligned with the planes of supporting components respectively.

8. The chamber as recited in claim 7, where the internal array can be attached to the chamber walls or be freely suspended.

9. The chamber as recited in claim 8, where the chamber and its internal array can be stationary or mobile.

10. The chamber as recited in claim 9, where the system can operate within wide range of pressure and temperature, from full vacuum to elevated pressures (for example, up to 20,000 psi) and from very low to high temperatures (for example, within the range of −269 deg C. to 1,680 deg C.).

11. The chamber as recited in claim 10, where the internal array configuration and geometry is such to provide optimized processing conditions for changing material properties and provides compensation for extreme processing conditions-generated stress and deformation.

12. The chamber as recited in claim 11, where the operation can involve agitation using array movement, whole system movement, relative movement of system and array, chamber movement, relative movement of chamber, system and array, product circulation, other medium injection, mechanical agitator/mixer, pulsation device, vibrating or oscillating device, or a bladder or bellows.

13. The chamber as recited in claim 12, The chamber walls and the array can be rigid or flexible with steady or changing shape and dimensions,

14. The chamber as recited in claim 13, the pathways and supporting components can form processing zones, with identical or varying zone geometry.

15. The chamber as recited in claim 14, where the processing zones can be formed by pathways, supporting components, or combinations of both.

16. The chamber as recited in claim 15, where, the bends of pathways in the central and peripheral processing zones can be such that the pathways come to a close proximity to the chamber wall within the range between 0 inch and 85 inch.

17. The chamber as recited in claim 16, where the thickness of supporting components can be constant or variable within the component and can vary from 0.000001 inch to 88 inch.

18. The chamber as recited in claim 17, where the distances between array pathways can vary from 0 to 120 inch.

19. The chamber as recited in claim 18, where the distances between array supporting components can vary from 0 to 160 inch.

20. The chamber as recited in claim 19, where the array of pathways is configured to allow the medium inside the pathway ducts to move from one side of the chamber to another in certain predetermined sequence thus allowing uniform interaction between the medium and the material in the chamber,

21. The chamber as recited in claim 20, where the supports S can be attached to the supporting components or to the pathways of the array.

22. The chamber as recited in claim 21, where the array can be configured with inner and outer pathways with the number of outer pathways increasing with the chamber dimensions.

23. The chamber as recited in claim 22, where the array can have various configurations of connections between the inner and outer pathways with connections varying in radii and bending planes.

24. The chamber as recited in claim 23, where the bending of pathways in the central and peripheral parts of the array can be in parallel or crossing planes.

25. The chamber as recited in claim 24, where the distances between pathways in crossing planes can be within the range from 0 to 160 inch.

26. The chamber as recited in claim 25, where the pathways and supporting components can be connected in multiple or single areas, or they can be not connected, but remain in a proximity with the distance range from 0 inch to 120 inch.

27. The chamber as recited in claim 26, where the supporting components can at various distances form the pathways, other components or the chamber walls with the distance range from 0 to 160 inch.

28. The chamber as recited in claim 27, where the internal and external surfaces of pathways can be smooth, rough, corrugated, dimpled, ribbed, grooved, or extended by other geometrical shapes regular or irregular.

29. The chamber as recited in claim 28, where the cross-sections of pathways can be circular, oval, elliptical, square, rectangular, triangular, flattened in different planes, or change irregularly.
